(19) United States
(12) Patent Application Publication
(10) Pub. No.: US 2013/0239687 A1
(43) Pub. Date: Sep. 19, 2013

(54) ACOUSTICAL WAVE MEASURING APPARATUS

(71) Applicant: Takaaki Nakabayashi, Kawasaki-shi (JP)

(72) Inventor: Takaaki Nakabayashi, Kawasaki-shi (JP)

(73) Assignee: CANON KABUSHIKI KAISHA, Tokyo (JP)

(21) Appl. No.: 13/883,821

(22) PCT Filed: Oct. 31, 2011
(86) PCT No.: PCT/JP2011/075527

§ 371 Date: May 7, 2013

(30) Foreign Application Priority Data
Nov. 30, 2010 (JP) 2010-265843

(51) Int. Cl. G01H 15/00

(52) U.S. Cl. CPC G01H 15/00
USPC 73/574

(57) ABSTRACT

An acoustical wave measuring apparatus capable of achieving an acoustic match even when the shape of a holding member changes largely along a scanning direction of a probe, including a holding member which holds a test object, a probe which receives an acoustical wave, and a sealing member, and the acoustical wave is received by running the probe for scanning with respect to the holding member while an acoustic matching agent for performing acoustic impedance matching between the probe and the holding member is injected into between a receiving surface and the holding member. The sealing member includes a portion with elasticity arranged at the receiving surface of the probe and is biased in a direction which brings the sealing member into contact with the holding member such that the portion contacts the holding member to seal a space between the receiving surface and the holding member.

### TECHNICAL FIELD

The present invention relates to an apparatus for measuring an acoustical wave, such as an ultrasonic apparatus adapted to run a probe for scanning along a scanning guide.

### BACKGROUND ART

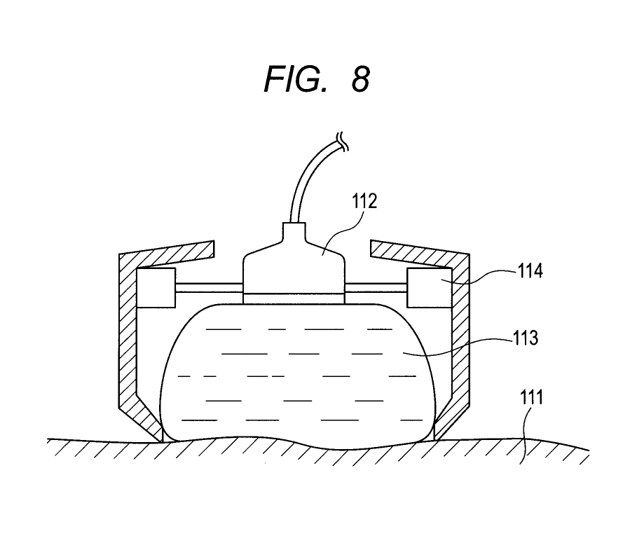

Ultrasonic apparatuses which acquire image information of a test object by running an ultrasonic probe for mechanical scanning have been known. Since an apparatus using ultrasonic waves performs acoustic impedance matching, the apparatus needs to be configured such that there is no gap to admit air between members, between which ultrasonic waves are transmitted. Note that an acoustic impedance match, an acoustic match, acoustic impedance matching in this specification means that the difference between the values of the acoustic impedances of two different substances is not more than about 20%. In the case of mechanical scanning, if the shape of a surface of a test object changes along a direction in which a probe is run for scanning, the distance between the probe and the test object changes. This may form a gap to disable acquisition of acoustic signals. As a unit for solving the problem, PTL 1 discloses an ultrasonic scanner including a matching agent whose shape changes in response to a change in the shape of a test object. FIG. 8 is a schematic view of the ultrasonic scanner disclosed in PTL 1. In the ultrasonic scanner, a couplant 113 having flexibility is provided as a matching agent between a test object 111 and a probe 112. The probe 112 is run for scanning by a driving mechanism 114. At the time of scanning, the flexible couplant is deformed according to rotation or linear scanning of the probe, and an acoustic impedance match between the probe 112 and the couplant 113 is maintained. Additionally, the flexible couplant is deformed to fit in with projections and recesses at a surface of the test object and comes into intimate contact with the test object, and an acoustic impedance match between the couplant and the test object is also maintained.

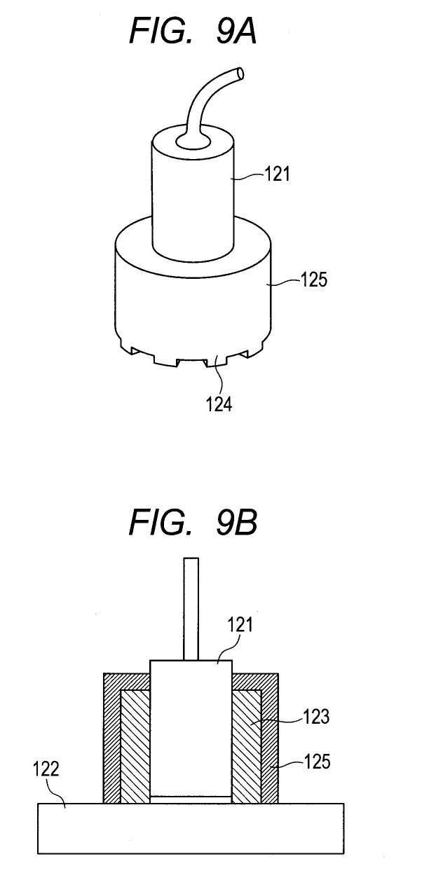

PTL 2 discloses an apparatus which performs acoustic impedance matching by applying a matching oil serving as a liquid matching agent between a compression plate which compresses a test object and a probe. FIG. 9A is a perspective view of a probe in PTL 2, and FIG. 9B is a sectional view of the probe. The apparatus in PTL 2 includes a sponge 123 which is moistened with a matching oil in order to fill a space between a probe 121 and a compression plate 122 with the matching oil. A cover 125 including spacers 124 between which gaps are formed is provided in order to form a thin film on the compression plate 122 from the matching oil, with which the sponge 123 is moistened. With this configuration, when the probe 121 moves along the compression plate 122, a thin film of the matching oil is deposited, which enables acoustic impedance matching between the probe and the compression plate.

### CITATION LIST

### Patent Literature

PTL 1: Japanese Patent No. 3,447,148

PTL 2: Japanese Patent Application Laid-Open No. 2003-325523

### SUMMARY OF INVENTION

### Technical Problem

However, if a probe is fastened to a flexible couplant, like the ultrasonic scanner disclosed in PTL 1, a range within which an ultrasonic image is acquired is limited to a range within which the couplant can change the shape. If scanning is performed while the probe slides on the flexible couplant, the couplant needs to be large enough to cover the image acquisition range, and it is hard to handle. If a variation in a test object is larger than a variation in the shape of the couplant, a gap may be formed between the probe and the test object and it disables acquisition of acoustic signals.

In the apparatus disclosed in PTL 2, if the compression plate is deformed when a test object is compressed, the spacers, between which the gaps for forming a thin film are formed, cannot keep the distance between the probe and the compression plate constant. This may form a gap to disable acquisition of acoustic signals. Especially in the case of mechanical scanning, the distance between the probe and the compression plate varies widely. Even if an elastic body of, e.g., rubber is provided, the apparatus can only cover an amount of deformation within a limited range. The process of thickening the compression plate or providing a frame to the compression plate in order to suppress deformation of the compression plate is also conceivable. However, if the process is adopted, signal attenuation may occur or the frame may cause formation of a dead space which prevents propagation of acoustical waves to reduce the image acquisition range.

In consideration of the problems, an acoustical wave measuring apparatus according to the present invention includes a holding member which holds a test object, a probe which receives an acoustical wave, and a sealing member, and the acoustical wave is received by running the probe for scanning with respect to the holding member while an acoustic matching agent for performing acoustic impedance matching between the probe and the holding member is injected into between a receiving surface of the probe and the holding member. The sealing member includes a portion with elasticity that is arranged to surround the receiving surface and is biased in a direction which brings the sealing member into contact with the holding member such that the portion with elasticity contacts the holding member to seal a space between the receiving surface and the holding member.

### Advantageous Effects of Invention

According to the present invention, a solid matching agent is not necessary, and an image acquisition is not limited to a particular range. Additionally, attachment of a matching agent is also unnecessary, which leads to ease of handling. Furthermore, since a sealing member is biased to be movable, even when the distance between a holding member and a probe changes during scanning, an acoustic match between the probe and the holding member can be maintained.

Further features of the present invention will become apparent from the following description of exemplary embodiments with reference to the attached drawings.

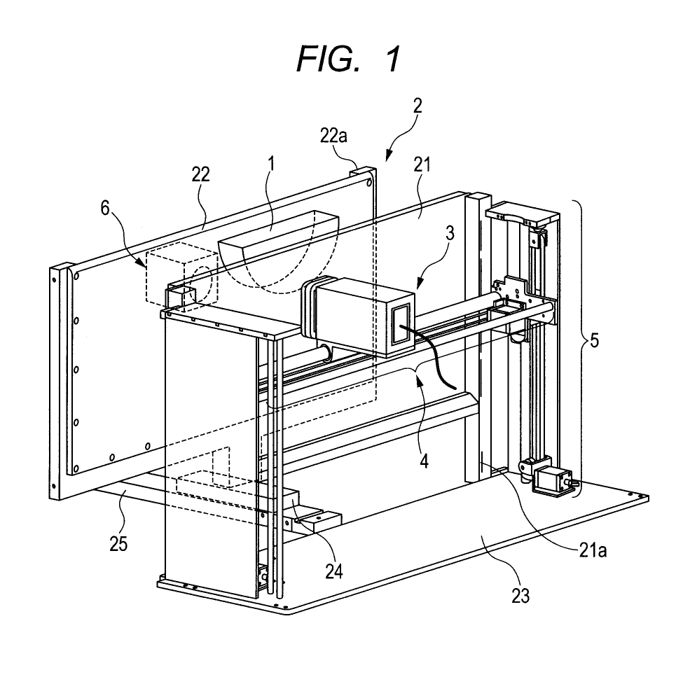

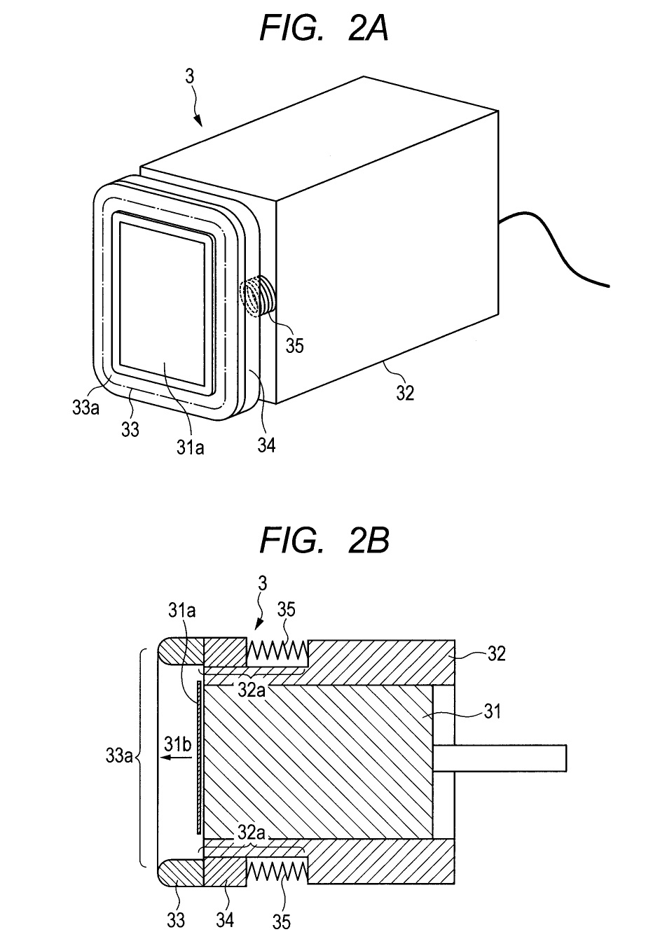

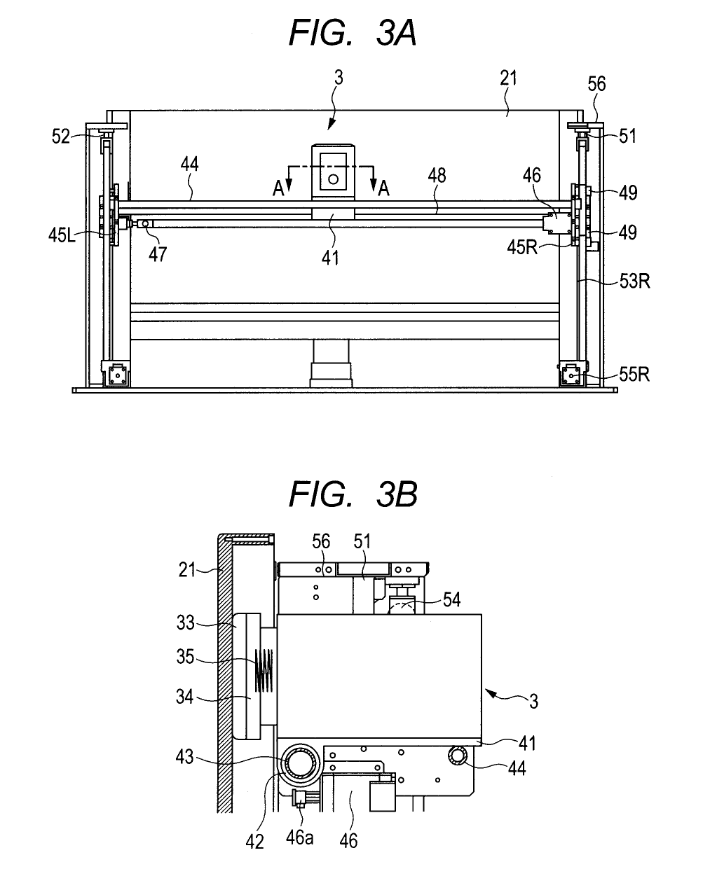

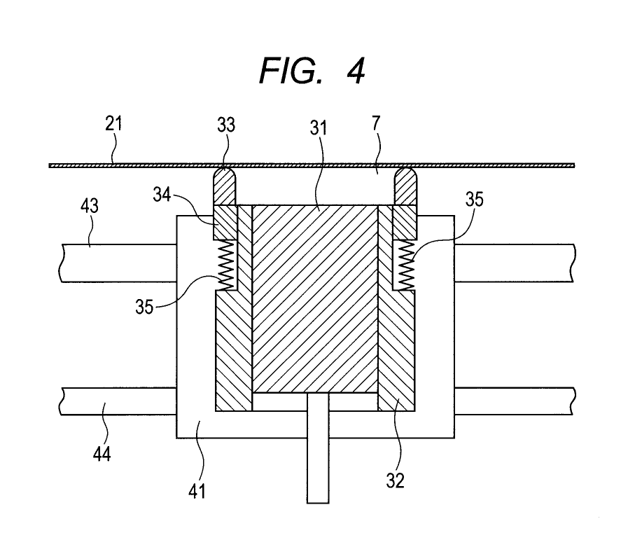

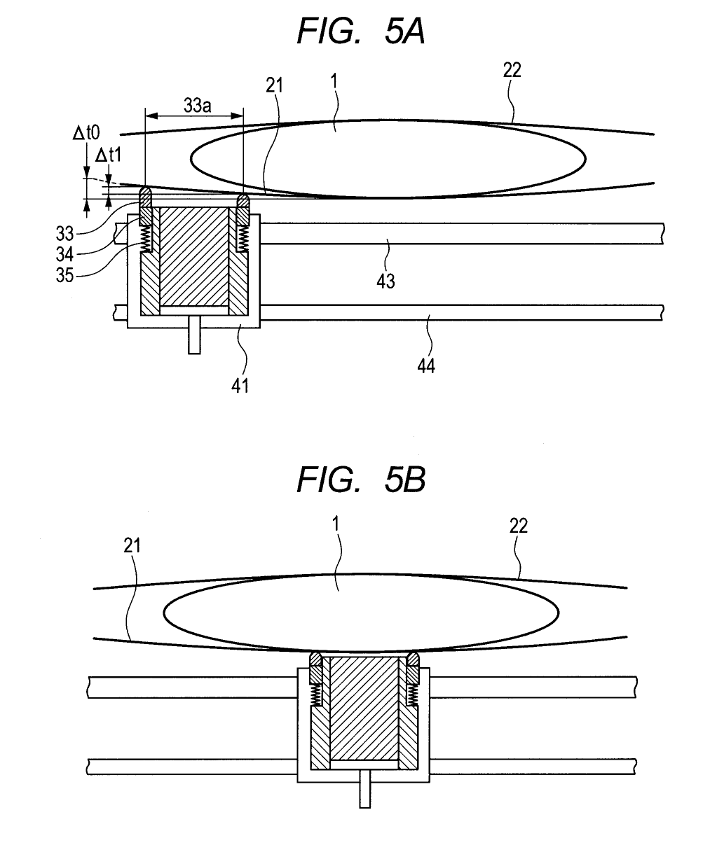

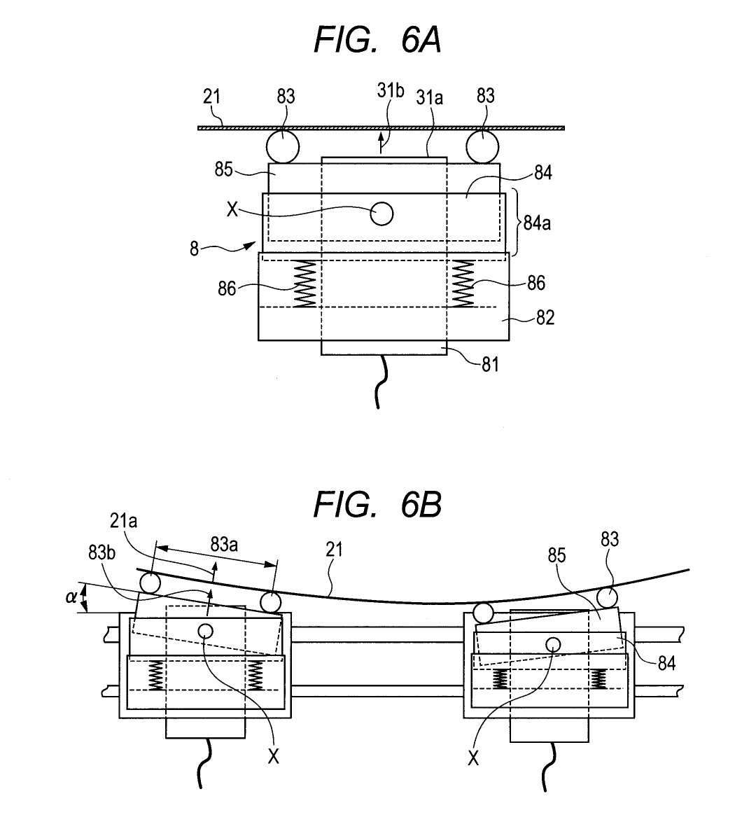

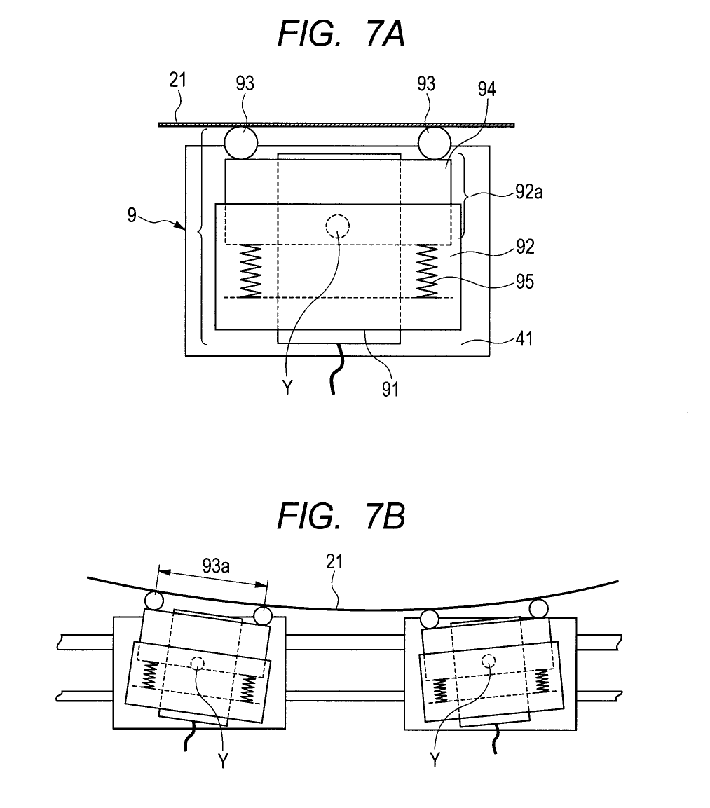

### BRIEF DESCRIPTION OF DRAWINGS

[FIG. 1]FIG. 1 is a perspective view of a main portion of an acoustical wave measuring apparatus according to a first embodiment.

[FIG. 2A]FIG. 2A is a perspective view of a probe unit according to the first embodiment.

[FIG. 2B]FIG. 2B is a longitudinal sectional view of the probe unit according to the first embodiment.

[FIGS. 3A and 3B]FIGS. 3A and 3B are a front view and a side view, respectively, of the acoustical wave measuring apparatus according to the first embodiment.

[FIG. 4]FIG. 4 is a sectional view taken along line A-A in FIG. 3A.

[FIGS. 5A and 5B]FIGS. 5A and 5B are sectional views taken along line A-A in FIG. 3A when a living body to be measured is held.

[FIG. 6A]FIG. 6A is a schematic view illustrating a probe unit in an acoustical wave measuring apparatus according to a second embodiment.

[FIG. 6B]FIG. 6B is a schematic view when the probe unit is run for scanning in the second embodiment.

[FIG. 7A]FIG. 7A is a schematic view illustrating a probe unit and a carrier in an acoustical wave measuring apparatus according to a third embodiment.

[FIG. 7B]FIG. 7B is a schematic view when the probe unit is run for scanning in the third embodiment.

[FIG. 8]FIG. 8 is a schematic view of a conventional ultrasonic scanner.

[FIG. 9A]FIG. 9A is a perspective view of a probe in a conventional ultrasonic apparatus.

[FIG. 9B]FIG. 9B is a sectional view of the probe in the conventional ultrasonic apparatus.

### DESCRIPTION OF EMBODIMENTS

A feature of the present invention lies in inclusion of a sealing member which is biased in a direction bringing the sealing member into contact with a holding member such that an elastic portion arranged at a receiving surface of a probe contacts the holding member to seal a space between the receiving surface and the holding member and acoustical wave coupling by acoustic matching between the probe and the holding member. Based on the concept, an acoustical wave measuring apparatus according to the present invention has a basic configuration as described above. In the present invention, any type of probe (e.g., a transducer using piezoceramic, a Capacitive Micro-Machined Ultrasonic Transducer (CMUT) of a capacitance type, a Magnetic Micro-Machined Ultrasonic Transducer (MMUT) using a magnetic film, or a Piezoelectric Micro-Machined Ultrasonic Transducer (PMUT) using a piezoelectric thin film) can be adopted as a probe serving as an electromechanical transducer. Acoustical waves in this specification include ones called a sound wave, an ultrasonic wave, and a photoacoustic wave. Examples of an acoustical wave include an acoustical wave which is generated inside an object to be measured when light such as a near infrared ray (an electromagnetic wave) is applied into the object to be measured and a reflected acoustical wave which is reflected inside an object to be measured when an acoustical wave is transmitted into the object to be measured.

Embodiments of an acoustical wave measuring apparatus according to the present invention will be described below.

### First Embodiment

FIG. 1 illustrates a main portion of an ultrasonic apparatus as a first embodiment of an acoustical wave measuring apparatus according to the present invention. The ultrasonic apparatus according to the present embodiment is an ultrasonic apparatus of a mechanical scanning type which acquires an image of the inside of a living body using photoacoustic effects. The ultrasonic apparatus according to the present embodiment includes a holding mechanism 2 for holding the position of a living body 1 serving as a test object, a probe unit 3, a horizontal scanning mechanism 4, a vertical scanning mechanism 5, and a light projecting unit 6. The probe unit 3 is a unit for receiving acoustical waves. The horizontal scanning mechanism 4 and vertical scanning mechanism 5 are mechanisms for running the probe unit 3 for scanning horizontally and vertically with respect to a fixed holding plate 21. The light projecting unit 6 is a unit for applying light to the living body 1. The living body 1 is held while sandwiched between the fixed holding plate 21 serving as a holding member and a movable holding plate 22 also serving as a holding member and arranged to face the fixed holding plate 21. The fixed holding plate 21 is attached to a frame 21a which is fixed to a base 23. The movable holding plate 22 is securely attached to a fixed plate 22a. The fixed plate 22a is fixed to a linear guide 24 which is provided on a linear guide base 25. That is, the movable holding plate 22 is movable along the linear guide 24 in a direction toward the fixed holding plate 21. In the present embodiment, a probe is provided on the fixed holding plate 21 side. However, according to the present invention, a probe may be provided on the movable holding plate 22 side or may be provided for each holding plate.

A material which matches well acoustically with the test object 1 (i.e., a material whose acoustic impedance is matched to the acoustic impedance of the test object 1) can be used as the material for the fixed holding plate 21. Polymethylpentene is especially suitable. As illustrated in the perspective view in FIG. 2A and the longitudinal sectional view in FIG. 2B, the probe unit 3 includes a probe 31, a housing 32, an oil seal 33 which constitutes a main portion of a sealing member, an oil seal base 34, and a compression spring 35 serving as a biasing member. Note that the word “biasing” in this specification refers to applying force or pressure and can be interchanged with pressurization. The probe 31 is fixed to the housing 32. The oil seal 33 is attached to the oil seal base 34. Although the oil seal 33 including an elastic portion is arranged to surround a receiving surface of the probe 31 to have a hollow square shape in the present embodiment, the shape of the oil seal 33 is not limited to this. For example, a shape open at an upper surface (a surface toward a direction opposite to a gravity direction) may be adopted as long as a matching oil 7 (to be described later) does not leak. An alternate long and short dash line in the oil seal 33 indicates a ridge which is to contact the fixed holding plate 21. Any material that has elasticity enough to absorb an amount Δt1 of deformation (illustrated in FIGS. 5A and 5B) of the fixed holding plate 21 within a range 33a enclosed by the alternate long and short dash line may be used for the oil seal 33, and silicon rubber can be used, for example. That is, the oil seal 33 only needs to have elasticity enough to achieve a difference not less than the amount Δt1 of deformation between the distance of a front end of the oil seal 33 when the oil seal 33 is elastically deformed to the maximum and the distance when the oil seal 33 is not elastically deformed. Although the oil seal 33 may be wholly made of an elastic material, it suffices that at least a front end portion of the oil seal 33 is made of a material having the above-described degree of elasticity. The housing 32 and oil seal base 34 have a fitting portion 32a at which the housing 32 and oil seal base 34 fit in with each other. The fitting portion 32a is configured to enable the oil seal base 34 to move along a normal direction 31b of a receiving surface 31a of the probe 31. The fitting portion 32a can include a gap within which leakage of the matching oil 7 that affects measurement can be avoided.

The movable distance in the normal direction 31b of the oil seal base 34 is set to be larger than a total amount Δt0 of deformation (illustrated in FIGS. 5A and 5B) of the fixed holding plate 21 caused by a force generated when the living body 1 is held. The compression spring 35 serving as the biasing member is provided between the housing 32 and the oil seal base 34, and the oil seal base 34 and oil seal 33 are biased toward the fixed holding plate 21 by a biasing force of the compression spring 35. That is, the oil seal base 34 and oil seal 33 are biased in a contact direction for contact with the fixed holding plate 21 such that the front end portion of the oil seal 33 comes into intimate contact with the fixed holding plate 21 to seal in the matching oil 7. In the present embodiment, the oil seal 33 is biased by the compression spring 35 such that the contact direction is parallel to the normal direction 31b of the receiving surface of the probe. If the biasing force of the compression spring 35 is weaker than an elastic force of the oil seal 33 when deformed, the oil seal 33 may contact the fixed holding plate 21 only on one side. For this reason, in the present embodiment, the biasing force of the compression spring 35 can be set to be stronger than a force required for the oil seal 33 to be elastically deformed by Δt1.

As illustrated in FIGS. 3A and 3B, the probe unit 3 is attached to a carrier 41 which is provided at the horizontal scanning mechanism 4. The carrier 41 includes a bearing 42 which fits on a horizontal main shaft 43 serving as a horizontal guide. A horizontal shaft 44 is provided in parallel to the horizontal main shaft 43 to restrict movement in a direction of rotation about the horizontal main shaft 43 of the carrier 41. The horizontal main shaft 43 and horizontal shaft 44 are fixed to a right side plate 45R and a left side plate 45L. A horizontal drive motor 46 which drives the carrier 41 is attached to the right side plate 45R while a timing pulley 47 is attached to the left side plate 45L. A horizontal timing belt 48 is coupled to a lower portion of the carrier 41. The timing belt 48 engages with a timing pinion 46a which is provided at the horizontal drive motor 46 and the timing pulley 47, and power of the horizontal drive motor 46 is transmitted to the carrier 41. A bearing 49 which fits on a vertical main shaft 51 (to be described later) is provided at the right side plate 45R. The horizontal scanning mechanism 4 is vertically driven by the vertical scanning mechanism 5. In the horizontal scanning mechanism 4, the bearing 49 is fit on the vertical main shaft 51 serving as a vertical scanning guide, and the position in a direction of rotation of the horizontal scanning mechanism 4 is restricted by a detent (not shown) which is coupled to the left side plate 45L and a vertical shaft 52. A right vertical timing belt 53R is coupled to the right side plate 45R. The right vertical timing belt 53R engages with a vertical timing pulley 54 which is provided at a top plate 56 and a vertical timing pinion (not shown) which is provided at a vertical drive motor 55R, and power of the vertical drive motor 55R is transmitted to the horizontal scanning mechanism 4. A driving mechanism on the left side is similar to the driving mechanism on the right side. A belt is coupled to the left side plate 45L, and motor drive is transmitted. With the above-described configuration, the probe unit 3 can be horizontally and vertically run for scanning.

The light projecting unit 6 can emit light with a light source (not shown) and an optical system which guides light to the light projecting unit. The light projecting unit 6 can be horizontally and vertically run for scanning by being attached to scanning mechanisms that is similar to the scanning mechanisms for the probe unit 3. FIG. 4 is a sectional view taken along line A-A in FIG. 3A. The oil seal 33 is in intimate contact with the fixed holding plate 21 under the biasing force of the compression spring 35. The expression “intimate contact” refers to a state in which the varying amount of the matching oil 7 can be kept so as not to affect acoustic coupling during image acquisition. The matching oil 7 serving as an acoustic matching agent which couples acoustical waves between the probe 31 and the fixed holding plate 21 is injected into a space which is formed between the fixed holding plate 21 and the probe 31 by the oil seal 33. Although castor oil is suitable as the matching oil 7, the present invention is not limited to this, and any other liquid such as water may be used instead. That is, any substance may be used as long as the substance intervenes between the receiving surface of the probe and the holding plate and can perform acoustic impedance matching between the probe and the acoustic matching agent and acoustic impedance matching between the acoustic matching agent and the holding plate to couple acoustical waves. The matching oil 7 is desirably degassed. In FIG. 4, the living body 1 is not held, and the fixed holding plate 21 is not deformed. That is, in the state in FIG. 4, the distance between the horizontal main shaft 43 and the fixed holding plate 21 is the longest.

When an image of the living body 1 is to be acquired, the living body 1 is inserted between the fixed holding plate 21 and the movable holding plate 22. The movable holding plate 22 is moved toward the fixed holding plate 21 by a pressure holding mechanism (not shown) such as a mechanism using a trapezoidal thread and a bevel gear or an air cylinder mechanism, and the living body 1 is held between the movable holding plate 22 and the fixed holding plate 21 while a brake (not shown) is put on. In order to achieve an acoustic match, gel may be applied or a water bag may be used between the living body 1 and the fixed holding plate 21 such that an air gap is not formed. After that, the horizontal drive motor 46 and vertical drive motor 55R drive the probe 31 to move to a site of the living body 1 whose image is desired to be acquired. Similarly, the light projecting unit 6 is moved to a position opposed to the probe 31. The process of emitting light while performing scanning with the positions of the probe unit 3 and light projecting unit 6 synchronized with each other may be adopted as a method for acquiring an image, in addition to the above-described process of emitting light after moving the probe unit 3 to a site whose image is desired to be acquired. When the living body 1 is irradiated with emitted light, an acoustical wave is generated. The acoustical wave is received by the probe 31, and an acoustic signal based on the acoustical wave is subjected to publicly known image reconstruction. With this process, an image can be acquired.

The states of the fixed holding plate 21 and probe unit 3 when the living body 1 is held is as follows. FIGS. 5A and 5B are sectional views taken along line A-A in FIG. 3A in the state where the living body 1 is held, and the fixed holding plate 21 is deformed. The fixed holding plate 21 is subjected to a force from the living body 1 resulting from a compressive force of the movable holding plate 22 and is deformed, and the distance of the fixed holding plate 21 to the horizontal main shaft 43 varies. FIG. 5A illustrates a case where the probe unit 3 is at a position during movement to a site whose image is desired to be acquired. FIG. 5B illustrates a case where the probe unit 3 is at a position where the distance of the horizontal main shaft 43 to the fixed holding plate 21 is the shortest. When the probe unit 3 is run for scanning, and the distance of the horizontal main shaft 43 to the fixed holding plate 21 becomes shorter, the oil seal base 34 is subjected to a force via the oil seal 33 and compresses the compression spring 35, and the position of the oil seal base 34 moves according to the distance to the fixed holding plate 21. Since the oil seal 33 has elasticity enough to absorb deformation of the fixed holding plate 21 within the range 33a and maintain intimate contact with the fixed holding plate 21, the matching oil 7 does not leak. When the probe unit 3 is at a position nearest to the fixed holding plate 21, the oil seal base 34 is at a position when the oil seal base 34 is moved toward the fixed holding plate 21 for the longest distance. However, since the movable distance in the normal direction 31b of the oil seal base 34 is set to be larger than an amount of deformation of the fixed holding plate 21, deformation of the fixed holding plate 21 does not cause compression of the oil seal 33 to the limit to apply stress to the probe unit 3. Similarly, when the horizontal main shaft 43 and fixed holding plate 21 become farther away from each other, the oil seal base 34 moves according to the distance of the horizontal main shaft 43 to the fixed holding plate 21, by the biasing force of the compression spring 35. That is, in a configuration without the compression spring 35 the total amount Δt0 of deformation of the fixed holding plate 21 needs to be kept at or below the amount Δt1, by which the oil seal can be deformed. In the present embodiment with the compression spring 35, however, the fixed holding plate 21 can be deformed by the amount Δt1 of deformation or more. Note that the oil seal 33 decreases a little due to, e.g., adhesion to the fixed holding plate 21 during scanning when the probe unit 3 moves on the fixed holding plate 21. A change in the distance between the probe unit 3 and the fixed holding plate 21 causes the volume of a space between the fixed holding plate 21 and the probe 31 which is filled with the oil seal 33 to fluctuate a little. Accordingly, if the space between the fixed holding plate 21 and the receiving surface of the probe 31 is charged with the oil seal 33, a unit is desirably provided to put the oil seal 33 into and out of the space, maintain a fully charged state of the space, and cause the space to function well to achieve an acoustic match.

It is desirable in image reconstruction to provide a unit which detects the amount of movement of the oil seal base 34 and a unit which measures the distance between the probe 31 and the fixed holding plate 21 and reconstruct an image with the thickness of the matching oil 7 varying depending on a scanning position in mind.

Similar method as the horizontal scanning described above can be applied to vertical scanning. Leakage of the matching oil 7 can also be prevented even if the fixed holding plate 21 is vertically deformed.

As described above, a solid matching agent is not necessary in the present embodiment. Therefore, an image acquisition range is not limited to a particular one, and an image can be acquired within a scannable range for the probe unit 3. Since the sealing member is biased to be movable, even when the distance between the holding plate and the scanning guide changes during scanning, an acoustic match can be maintained. Accordingly, a permissible amount of deformation of the holding plate increases, and attenuation of acoustical waves can be suppressed by reducing the thickness of the holding plate. Even if a frame for suppressing deformation of the holding plate is provided, the size of the frame can be reduced, and a dead space formed by the frame can be reduced.

### Second Embodiment

A second embodiment is a modification of the first embodiment and is different in the configuration of a probe unit. Components other than a probe unit in the second embodiment are the same as the components in the first embodiment, and a description of the components will be omitted. As illustrated in FIG. 6A that is a schematic view of a probe unit 8 in the present embodiment, the probe unit 8 includes a probe 81, a housing 82, an oil seal 83, a linear motion base 84, a rotation base 85, and a compression spring 86. The probe 81 is fixed to the housing 82. The rotation base 85 is attached to the linear motion base 84 so as to rotate about X. Since the oil seal 83 is attached to the rotation base 85, the oil seal 83 is also rotatable. The oil seal 83 is made of an elastic body which enables the oil seal 83 to follow inclination of a fixed holding plate 21 and absorb deformation of the fixed holding plate 21 within a range 83a where the probe 81 contacts the fixed holding plate 21 and to come into intimate contact with the fixed holding plate 21. An inner surface of the housing 82 and an outer surface of the linear motion base 84 have a fitting portion 84a at which the inner surface and outer surface fit in with each other. The fitting portion 84a is configured to enable the linear motion base 84 to move in a normal direction 31b of a receiving surface 31a of the probe 31. The movable distance in the normal direction 31b of the linear motion base 84 is set to be larger than an amount of deformation of the fixed holding plate 21 caused by a force generated when a living body 1 is held. The compression spring 86 is provided between the housing 82 and the linear motion base 84, and the linear motion base 84, rotation base 85, and oil seal 83 are biased toward the fixed holding plate 21 by a biasing force of the compression spring 86. The probe unit 8 is also sealed with an elastic body (not shown) so as to prevent leakage of a matching oil 7 caused by displacements of the linear motion base 84 and rotation base 85.

Action of the probe unit 8 when the fixed holding plate 21 is deformed is as follows. FIG. 6B is a schematic view of a case where the probe unit 8 is run for scanning along the deformed fixed holding plate 21. The oil seal 83 is biased toward the fixed holding plate 21 via the linear motion base 84 and rotation base 85 by the biasing force of the compression spring 86. The biasing force rotates the rotation base 85 in a direction which brings the whole oil seal 83 into contact with the fixed holding plate 21 with respect to the linear motion base 84. Namely, the rotation base 85 rotates towards a direction such that contact direction 83b of the oil seal 83 to the fixed holding plate 21 coincides with a normal direction 21a of the fixed holding plate 21 within a range where the oil seal 83 is in contact with the fixed holding plate 21. Thus, when the probe unit 8 is run for scanning, the orientation of the oil seal 83 follows the inclination of the fixed holding plate 21 in response to deformation of the fixed holding plate 21. Accordingly, in the present embodiment, the oil seal 83 can rotate such that the contact direction of the oil seal 83 follows the normal direction of the fixed holding plate 21 and is biased by the compression spring 86. When the rotation base 85 has an inclination of a, the oil seal 83 absorbs deformation of the fixed holding plate 21 within the range 83a that is in a normal direction of a direction of rotation of the rotation base 85, and intimate contact between the fixed holding plate 21 and the oil seal 83 is maintained. Note that since the probe 81 does not rotate, the receiving surface of the probe 81 is inclined with respect to the fixed holding plate 21. Although FIG. 6B illustrates only rotation about one axis, the probe unit 8 can cope with horizontal deformation and vertical deformation of the fixed holding plate 21 by providing a mechanism for rotation about two axes.

In the present embodiment as well, it is desirable in image reconstruction to provide a unit which detects the amount of movement of the oil seal base and a unit which measures the distance between the probe and the fixed holding plate 21 and reconstruct an image with the thickness of the matching oil varying depending on a scanning position in mind.

According to the present embodiment, rotation of the rotation base 85, to which the oil seal 83 is attached, can cause the orientation of the oil seal 83 to follow the inclination of the fixed holding plate 21 when deformed. Since an amount of deformation of the oil seal 83 that needs to absorb deformation of the fixed holding plate 21 is reduced, conditions concerning the material for and the shape of the oil seal can be relaxed, in addition to the advantageous effects of the first embodiment. Further, the need to set the biasing force of the compression spring 86 to be stronger than an elastic force of the oil seal 83 is eliminated.

### Third Embodiment

FIG. 7A is a schematic view of a probe unit 9 and a carrier 41 according to a third embodiment. In the present embodiment, the probe unit 9 is provided to be rotatable about Y with respect to the carrier 41. The probe unit 9 includes a probe 91, a housing 92, an oil seal 93, an oil seal base 94, and a compression spring 95. The probe 91 is coupled to the housing 92. The oil seal 93 is coupled to the oil seal base 94. The oil seal base 94 and housing 92 have a fitting portion 92a. With this configuration, the oil seal base 94 is movable in a normal direction of a receiving surface of the probe 91 with respect to the housing 92 while the oil seal base 94 is biased toward a fixed holding plate 21 by a biasing force of the compression spring 95. The movable distance of the oil seal 93 is set to be larger than an amount of deformation of the fixed holding plate 21 caused by a force generated when a living body 1 is held.

FIG. 7B is a sectional view of a state of the probe unit 9 with respect to the deformed fixed holding plate 21 and illustrates a difference in the state of the probe unit 9 caused by a difference in position. The probe unit 9 according to the present embodiment is provided with the compression spring 95, which biases the oil seal base 94 attached to the carrier 41 so as to rotate together with the probe 91. For this reason, the orientation of the probe unit 9 follows the normal direction of the surface of the fixed holding plate 21 by cooperation of a contact force between the oil seal 93 and the fixed holding plate 21 and the biasing force of the compression spring 95. That is, action of the biasing force of the compression spring 95 moves the oil seal base 94 in response to a change in the distance of the fixed holding plate 21. Simultaneously, the probe unit 9 rotates by reaction resulting from the contact of the oil seal 93 with the fixed holding plate 21 to cause the orientation of the receiving surface to follow the normal direction. Accordingly, in the present embodiment, a direction of contact of the sealing member with the biased holding member follows not only the normal direction of the receiving surface of the probe but also a normal direction of a surface of the holding member. In the above-described manner, intimate contact of the oil seal 93 with the fixed holding plate 21 is maintained.

In the present embodiment as well, it is desirable in image reconstruction to provide a unit which detects the amount of movement of the oil seal base and a unit which measures the distance between the probe and the fixed holding plate 21 and reconstruct an image with the thickness of the matching oil varying depending on a scanning position in mind. In the present embodiment, the receiving surface of the probe is not inclined with respect to the surface of the fixed holding plate 21 and is kept substantially parallel, which makes the process of performing image reconstruction easier with the thickness of the matching oil in mind.

The configuration of the present embodiment can also achieve the same advantageous effects as the advantageous effects in the first and second embodiments. In the present embodiment, conditions concerning the material for and the shape of the oil seal can be relaxed, and the need to set the biasing force of the compression spring 95 to be stronger than an elastic force of the oil seal 93 is eliminated, as in the second embodiment.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-265843, filed Nov. 30, 2010, which is hereby incorporated by reference herein in its entirety.

1. An acoustical wave measuring apparatus comprising:
a holding member which holds a test object;
a probe which receives an acoustical wave; and
a sealing member which includes a portion with elasticity that is arranged to surround a receiving surface of the probe and contacts the holding member such that the portion with elasticity contacts the holding member to seal a space between the receiving surface and the holding member,
wherein the acoustical wave is received by running the probe for scanning with respect to the holding member while an acoustic matching agent for performing acoustic impedance matching between the probe and the holding member is injected into a space between the receiving surface and the holding member.

2. The acoustical wave measuring apparatus according to claim 1, wherein the sealing member is movable in response to a change in a distance between a scanning guide along which the probe moves and the holding member.

3. The acoustical wave measuring apparatus according to claim 2, further comprising a pressurizing member, wherein the sealing member is pressed against the holding member by the pressurizing member.

4. The acoustical wave measuring apparatus according to claim 2, wherein the sealing member is rotatable such that a contact direction of the sealing member to the holding member follows a normal direction of the holding member within a range where the sealing member is in contact with the holding member.

5. The acoustical wave measuring apparatus according to claim 3, wherein a force of the press by the pressurizing member is stronger than a force required for the portion to be elastically deformed and come into intimate contact with the holding member.
